(19) United States
(12) Patent Application Publication
(10) Pub. No.: US 2015/0138615 A1
(43) Pub. Date: May 21, 2015

(54) DEVICE AND METHOD FOR CREATING STEREOGRAMS WITH LARGE VIEWING ANGLE AND HIGH 2D IMAGE RESOLUTION

(71) Applicant: ELECTRONICS AND TELECOMMUNICATIONS RESEARCH INSTITUTE, Daejeon (KR)

(72) Inventors: Tae One KIM, Daejeon (KR); Bong Ho LEE, Daejeon (KR); Kwan Jung OH, Daejeon (KR); Hyon Gon CHOO, Daejeon (KR); Kyung Ae MOON, Daejeon (KR); Jin Woong KIM, Daejeon (KR)

(73) Assignee: ELECTRONICS AND TELECOMMUNICATIONS RESEARCH INSTITUTE, Daejeon (KR)

(21) Appl. No.: 14/167,437

(22) Filed: Jan. 29, 2014

(30) Foreign Application Priority Data
Nov. 21, 2013 (KR) 10-2013-0142164

(51) Int. Cl. G03H 1/26

(52) U.S. Cl. CPC G03H 1/268
USPC 359/23

(57) ABSTRACT

A method of generating a stereogram is disclosed. The method includes a first step of partially rendering a preset region of each of a plurality of images having different views to a memory, a second step of extracting a pixel at a corresponding location of the rendered preset region to generate a hogel image, and a third step of repeatedly performing the first step and the second step on a remaining region of each of the plural images to generate a hogel image sequence. Accordingly the stereogram generation method effectively generates a stereogram having high resolution.

This application claims priority to and the benefit of Korean Patent Application No. 10-2013-0142164, filed on Nov. 21, 2013, which is hereby incorporated by reference as if fully set forth herein.

### BACKGROUND OF THE INVENTION

1. Field of the Invention

The present invention relates to a device and method for generating a stereogram with a large viewing angle and high resolution, and more particularly, to a device and method for generating a stereogram image with a large viewing angle and high resolution by overcoming limitations of a conventional stereogram generation method and effectively recombining a plurality of image sequences captured by a plurality of cameras.

2. Discussion of the Related Art

A stereogram is a type of three-dimensional (3D) image similar to a 3D multi-view image used in a conventional multi-view 3D display and simultaneously has horizontal/vertical view differences compared with a typical multi-view 3D image (horizontal view difference). In addition, a stereogram has a wide viewing angle compared with a multi-view image to have properties whereby the number of viewpoints is remarkably increased.

In general, a stereogram image is generated from a two-dimensional (2D) image sequence having M×M resolution captured by N×N cameras. In general, the resolution of images and the number of cameras need not necessarily be square sized, they can be generalized to any non-square sizes such as M×P and N×Q. In reality, the stereogram image is composed of M×M hogels each of which corresponds to an image having N×N pixels. As a basic method for generating a hogel image sequence, input N×N image files stored in a hard disk are simultaneously opened and a pixel recombination procedure is performed to form M×M hogel sequences. This method is referred to as a basic method. According to the basic method, in reality, when N and M are not great, for example, when N and M are equal to or less than 100, a stereogram can be generated within a reasonably expected time. However, when N is greater than 100, a problem arises for generation time of a stereogram exponentially increases with slow operations of reading image files from a storage disk.

In order to overcome this problem, a full rendering scheme may be simply considered. The full rendering scheme refers to a method of sequentially forming corresponding hogel image sequences by rendering N×N image sequences and directly performing a pixel rearrangement procedure while the N×N image sequences are completely rendered in a memory rather than being stored in a hard disk. However, in this method, when N and M are great, a physical memory size required to completely render an image sequence in a memory is increased to several hundreds of terabytes or more. Thus, there is a limit in generating a wide viewing angle and high resolution stereogram using the full rendering scheme.

Accordingly, there is a need for a technology for reducing time for generation of a wide viewing angle and high resolution stereogram and effectively generating the stereogram that does not depend upon memory size.

### SUMMARY OF THE INVENTION

Accordingly, the present invention is directed to a device and method for generating a stereogram with a large viewing angle and high resolution that substantially obviates one or more problems due to limitations and disadvantages of the related art.

An object of the present invention is to provide a device and method for generating a stereogram with a large viewing angle and high resolution, for reducing time for generating a stereogram and for flexibly realizing the stereogram generation independently of a physical memory capacity.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of generating a stereogram includes a first step of partially rendering a preset region of each of a plurality of images having different views to a memory, a second step of extracting a pixel at a corresponding location of each rendered preset region to generate a hogel image, and a third step of repeatedly performing the first step and the second step on a remaining region of each of the plural images to generate a hogel image sequence.

The preset region corresponds to a partial region of an image.

The preset region may be set in a column-wise or row-wise fashion.

The preset region may have a variable size.

The size of the preset region is dependent on and determined by an available size of memory space.

Note the image corresponding to the preset region can be CG-rendered as described up to now or it can be load from real or CG image files at a storage e.g., a hard disk.

In another aspect of the present invention, a stereogram generating device includes a memory for partially rendering a preset region of each of a plurality of images having different views, and a controller for rendering the preset region to the memory and extracting a pixel at a corresponding location of the rendered preset region to generate a hogel image, wherein the controller repeatedly performs the rendering and the extracting on a remaining region of each of the plural images to generate a hogel image sequence.

The memory may be at least one of a random access memory (RAM) and a memory cache.

The controller may calculate a space of the memory, vary a size of the preset region and render the preset region.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a stereogram generating device according to an embodiment of the present invention;

FIG. 2 is a set of diagrams for explanation of a procedure for rendering a preset region of an image to a memory according to an embodiment of the present invention;

FIG. 3 is a diagram for explanation of a procedure for generating a hogel image according to an embodiment of the present invention; and

FIG. 4 is a flowchart of a method of generating a stereogram according to an embodiment of the present invention.

### DETAILED DESCRIPTION OF THE INVENTION

Reference will now be made in detail to the preferred embodiments of the present invention, examples of which are illustrated in the accompanying drawings. The features of the present invention will be more clearly understood from the accompanying drawings and should not be limited by the accompanying drawings.

Most of the terms used herein are general terms that have been widely used in the technical art to which the present invention pertains. However, some of the terms used herein may be created reflecting intentions of technicians in this art, precedents, or new technologies. Additionally, some of the terms used herein may be arbitrarily chosen by the present applicant. In this case, these terms are defined in detail below. Accordingly, the specific terms used herein should be understood based on the unique meanings thereof and the overall context of the present invention.

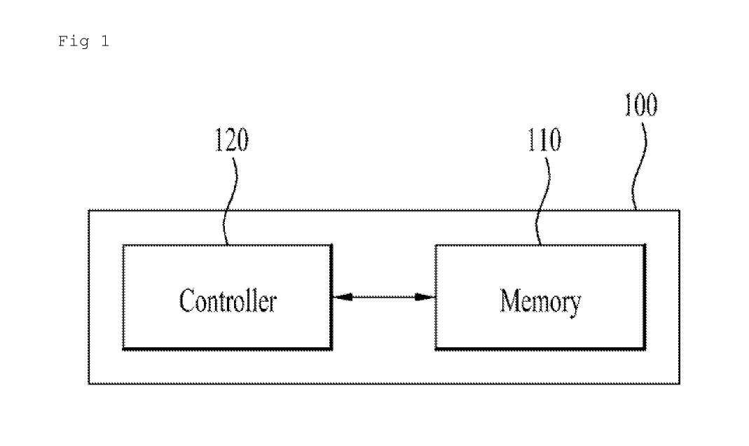

FIG. 1 is a block diagram of a stereogram generating device 100 according to an embodiment of the present invention.

Referring to FIG. 1, the stereogram generating device 100 includes a memory 110 and a controller 120.

The stereogram generating device 100 may include an input unit (not shown). The input unit may receive a plurality of images having different views. The plural images having different views may be an artificially-formed computer graphic image or an image captured by a camera.

The stereogram generating device 100 may include a photographing unit (not shown) having N×N cameras. The photographing unit may photograph an object using a camera included in the photographing unit.

The memory 110 renders a preset region of each of a plurality of images. The preset region corresponds to a partial region of an image. That is, each image is partially rendered according to available capacity of the memory 110. For example, the memory 110 may be embodied as at least one of a random access memory (RAM) and a memory cache. The preset region may have a variable size. The size of the preset region is dependent on and determined by an available size of memory space.

The controller 120 renders the preset region of each of the plural images to the memory 110. The controller 120 partially renders a predetermined region of each image. That is, the controller 120 renders a partial region of a necessary image among all images instead of full rendering using all three-dimensional (3D) image model data information to be rendered during image rendering. The partial region for rendering may be determined according to an available memory size. Thus, the stereogram generating device 100 does not depend upon a physical memory size and thus can perform partial variable rendering, and the stereogram generating device 100 does not use full rendering, thereby reducing rendering time. The controller 120 may calculate an available space of the memory 110 and may variably set a size of the partial region for rendering based on the calculation result.

The aforementioned method can be applied to a computer graphic (CG) image sequence. Alternatively, the method can also be applied in the same way to a real image sequence formed by photographing an object by a memory loading procedure. That is, the rendering procedure according to the present invention may be replaced by the loading procedure with respect to a real image sequence.

The controller 120 extracts a pixel at a corresponding location to the preset region that is rendered (or that is loaded with respect to the real image sequence) to generate a hogel image.

That is, the stereogram generating device 100 includes a controller for partially rendering the preset partial region of each of the plural images having different views using a preset memory region and extracting a pixel at a corresponding location of the preset memory region to generate a hogel image. The controller repeatedly performs rendering and extraction on the remaining regions of each of the plural images to generate a hogel image sequence.

A method of setting a region for rendering and a method of extracting a pixel will be described below in detail. Upon completely performing pixel extraction on the rendered preset region, the controller 120 repeatedly performs rendering and pixel extraction on the remaining portions of each of the plural images. The controller 120 repeats this procedure to perform a pixel recombination procedure on all plural images and generates a pixel image sequence that is a hogel image sequence corresponding to a currently set memory region. That is, since a currently rendered image sequence is a partial image sequence, the generated hogel image sequence is also a partial hogel sequence. The hogel image sequence is a series of images having 3D information and hologram components formed by recombining image pixels in order to generate a stereoscopic image.

The stereogram generating device 100 may include an image processor (not shown) separately from the controller 120. In this case, the aforementioned pixel extraction and hogel image generation may be performed by the image processor. The image processor may be embodied by hardware or software.

The stereogram generating device 100 may include a storage unit including the memory 110. That is, the storage unit may include a main memory such as a RAM and a ROM and an auxiliary memory such as a hard disk drive (HDD) and a solid state drive (SSD). The storage unit may store the generated hogel image sequence therein.

Hereinafter, a procedure for rendering a preset region of each of a plurality of images and a procedure for generating a hogel image will be described.

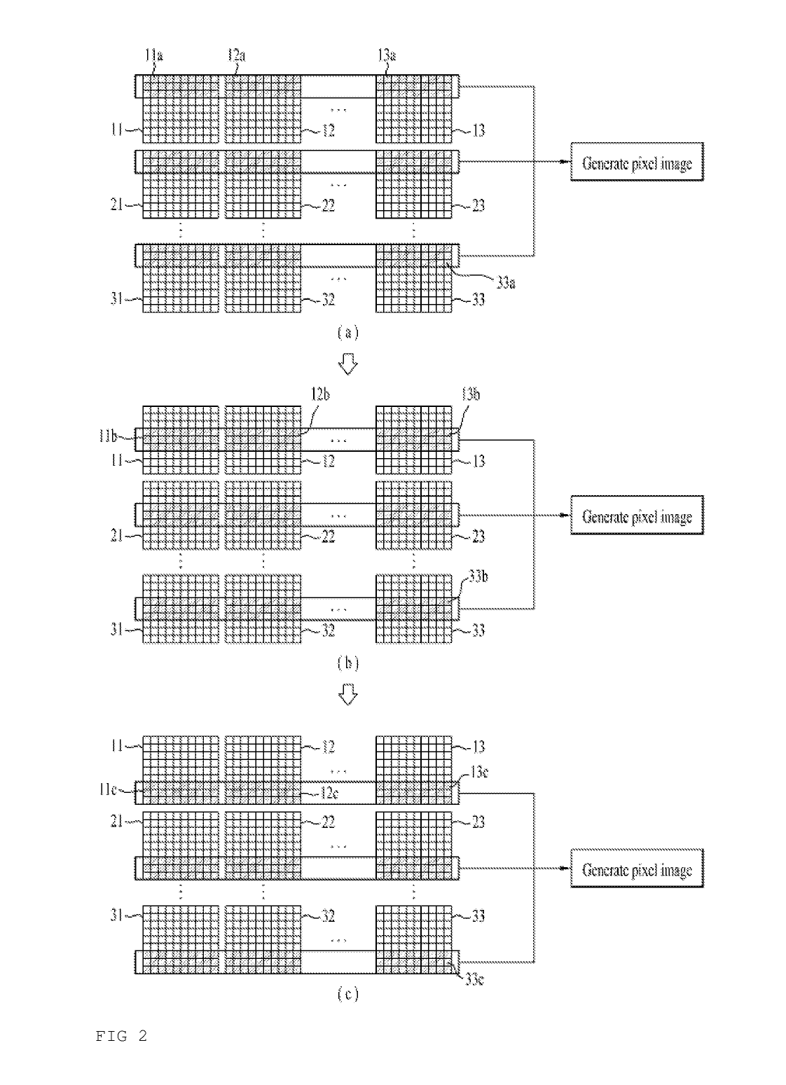

FIG. 2 is a set of diagrams for explanation of a procedure for rendering a preset region of an image to a memory according to an embodiment of the present invention.

Referring to FIG. 2(A), a stereogram generating device receives a plurality of images 11, 12, 13, 21, 22, 23, 31, 32, and 33 having different views. The plural images 11, 12, 13, 21, 22, 23, 31, 32, and 33 contain the same object but have different views. The plural images 11, 12, 13, 21, 22, 23, 31, 32, and 33 may be stored in a storage unit.

The controller renders the preset region of each of the plural images having different views to the memory. In FIG. 2(A), first rows 11a, 12a, 13a, and 33a of each of the plural images are selected and rendered. Likewise, the controller may calculate an available capacity of the memory and set a size of image sequence to be rendered. The controller may directly set the size of the image sequence together with some rows or indirectly set the size of the image sequence based on memory capacity in consideration of the available memory capacity and the size of a currently rendered or loaded image region. In addition, the controller may select and render columns. The preset region may be set as at least one of rows and columns. That is, the preset region may be set in a column or row-wise fashion.

The controller extracts a pixel at a corresponding location of each region rendered to the memory to generate a hogel image. A procedure for generating the hogel image will be described below in more detail. Upon completely performing pixel extraction on the rendered region, the controller renders the following regions of each of the plural images to the memory.

Referring to FIG. 2(B), second three rows 11b, 12b, 13b, and 33b of each of a plurality of images 11, 12, 13, 21, 22, 23, 31, 32, and 33 are selected and rendered. As described with reference to FIG. 2(A), the controller extracts a pixel at a corresponding location of each region of the second rows rendered to the memory to generate a hogel image.

Referring to FIG. 2(C), last three rows 11c, 12c, 13c, and 33c of each of a plurality of 11, 12, 13, 21, 22, 23, 31, 32, and 33 are selected and rendered. The controller extracts a pixel at a corresponding location to each region of the last row rendered to the memory to generate a hogel image.

With reference to FIG. 2, the procedure for setting three rows of each of the plural images to a preset region and rendering the region to the memory by the controller has been described with regard to an embodiment of the present invention. However, this is purely exemplary and the controller may determine an image region to be rendered using various methods.

For example, the controller may calculate a memory available space and determine the size of the image region to be rendered. In addition, the controller may perform rendering on all regions of the plural images based on the size of the region determined once or may render the image region, the size of which varies every rendering time. For example, the controller may set three rows to a region for first rendering, set four rows to a region for second rendering, and set two rows to a region for last rendering. That is, upon rendering plural images having different views, the controller renders a partial image region in consideration of a currently available physical memory size. The controller extracts a pixel of each region rendered to the memory to generate a hogel image.

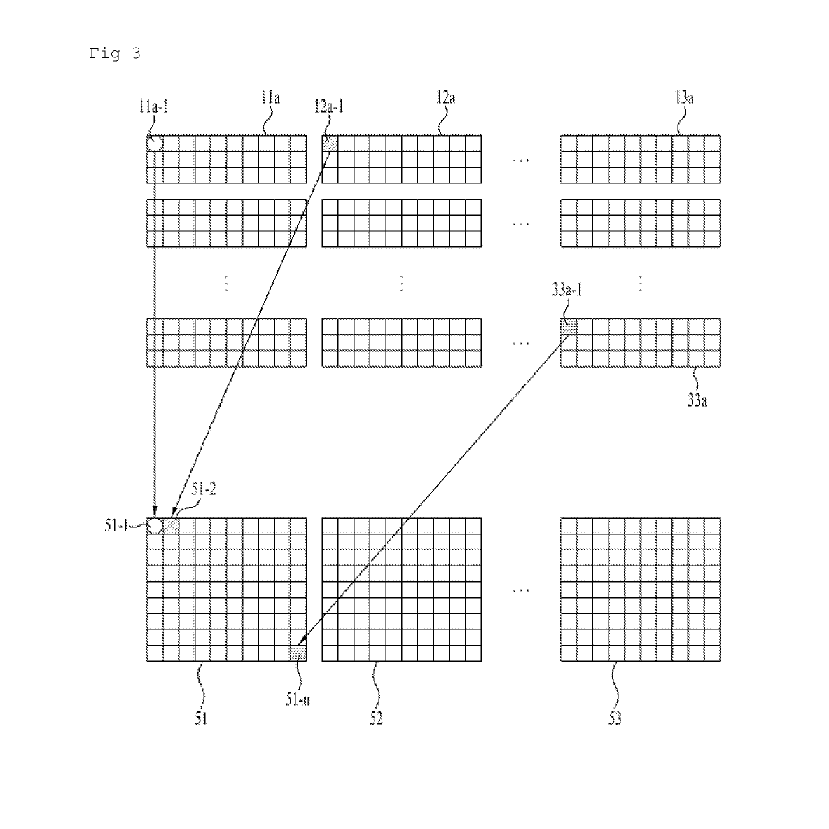

FIG. 3 is a diagram for explanation of a procedure for generating a hogel image according to an embodiment of the present invention.

Referring to FIG. 3, first three rows 11a, 12a, 13a, and 33a of each of a plurality of images are selected and rendered. A controller extracts a first pixel 11a-1 of a first rendered image 11a and arranges the first pixel 11a-1 in a first pixel 51-1 of a first hogel image 51. The controller extracts a first pixel 12a-1 of a second rendered image 12a and arranges the first pixel 12a-1 in a second pixel 51-2 of the first hogel image 51. The controller extracts a pixel of each rendered region and arranges the pixel on a hogel image using this method. Lastly, the controller extracts a first pixel 33a-1 of an Nth rendered image 33a and arranges the first pixel 33a-1 in an nth pixel 51-n of the first hogel image 51.

Via this pixel recombination procedure, the first hogel image 51 is completed. In the same way, hogel images 51, 52, and 53 corresponding to a pixel number of each rendered image is generated. The hogel image refers to a hogel image sequence. The hogel image sequence refers to a series of images having 3D information and hologram components formed by recombining image pixels in order to generate a stereoscopic image.

Upon completing the pixel recombination procedure on the region rendered to the memory, the controller renders another region in the plural image. The controller repeats the aforementioned procedure on a newly rendered image region. Via this procedure, hogel images generated with respect to all pixels are generated. A combination of hogel images is referred to as a hogel image sequence or a hogel image sequence. The controller generates a stereogram as a stereoscopic image using the generated hogel image sequence.

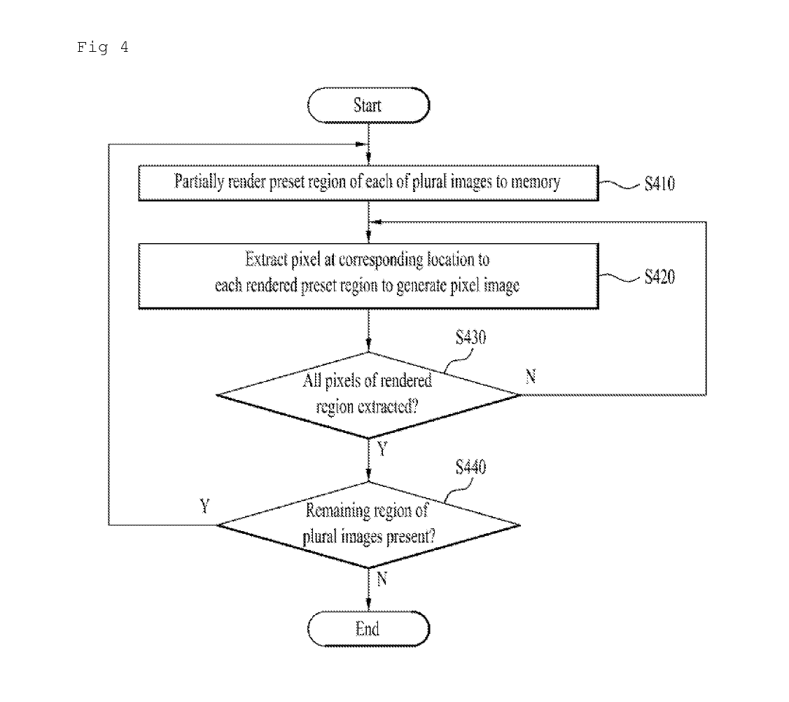

FIG. 4 is a flowchart of a method of generating a stereogram according to an embodiment of the present invention.

Referring to FIG. 4, a stereogram generating device renders a preset region of each of a plurality of images having different views to a memory (S410). Note the image corresponding to the preset region can be CG-rendered as described up to now or it can be load from real or CG image files at a storage e.g., a hard disk. The stereogram generating device renders only a partial region of an image among all images in consideration of an available physical memory size. For example, the rendering of the partial region of the image may be easily embodied using a function (e.g., glScissor function) that is basically provided by a general-purpose CG programming API such as OpenGL.

A stereogram generating device extracts a pixel at a corresponding location of each rendered preset region and generates a hogel image (S420). A procedure for extracting a pixel to generate a hogel image is referred to as a pixel recombination procedure. The pixel recombination procedure refers to a procedure for reading a pixel value at a corresponding location from the rendered image and generating a corresponding hogel image.

The stereogram generating device determines whether all pixels are extracted from the rendered region (S430). Upon determining that not all pixels have been extracted, the stereogram generating device extracts the remaining pixels and generates a new hogel image. In addition, upon determining that all pixels have been extracted, the stereogram generating device determines whether the remaining regions that are not rendered in a plurality of images are present (S440). Upon determining that the remaining regions that are not rendered in a plurality of images are present, the stereogram generating device renders a new region to the memory. Upon determining that the remaining regions are not present, the stereogram generating device completes the procedure. That is, the stereogram generating device repeats rendering and extraction on the remaining region of each of the plural images to generate a hogel image.

According to the aforementioned various embodiments of the present invention, a method and device for generating a stereogram may effectively generate a stereogram having a wide viewing angel and high resolution.

The device and method thereof according to the present invention is not limited to the configuration and method of the aforementioned embodiments, rather, these embodiments may be entirely or partially selected in many different forms.

The method of according to the present invention can be embodied as processor readable codes stored in a processor readable recording medium included in a terminal. The processor readable recording medium is any data storage device that can store programs or data which can thereafter be read by a processor. Examples of the processor readable recording medium include read-only memory (ROM), random-access memory (RAM), CD-ROMs, magnetic tapes, hard disks, floppy disks, flash memory, optical data storage devices, and so on, and also include a carrier wave such as transmission via the Internet. The processor readable recording medium can also be distributed over network coupled computer systems so that the processor readable code is stored and executed in a distributed fashion.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of generating a stereogram, the method comprising:
a first step of partially rendering a preset region of each of a plurality of images having different views to a memory;
a second step of extracting a pixel at a corresponding location of each rendered preset region to generate a hogel image; and
a third step of repeatedly performing the first step and the second step on a remaining region of each of the plural images to generate a hogel image sequence.

2. The method according to claim 1, wherein the preset region is set in a column-wise or row-wise fashion

3. The method according to claim 1, wherein the preset region has a variable size.

4. The method according to claim 3, wherein the size of the preset region is dependent on and determined by an available size of memory space.

5. The method according to claim 1, wherein the preset region is loaded from real or computer graphic files.

6. A stereogram generating device comprising:
a memory for partially rendering a preset region of each of a plurality of images having different views; and
a controller for rendering the preset region to the memory and extracting a pixel at a corresponding location of the rendered preset region to generate a hogel image,
wherein the controller repeatedly performs the rendering and the extracting on a remaining region of each of the plural images to generate a hogel image sequence.

7. The stereogram generating device according to claim 6, wherein the memory is at least one of a random access memory (RAM) and a memory cache.

8. The stereogram generating device according to claim 6, wherein the controller calculates a space of the memory, varies a size of the preset region, and renders the preset region.

9. A method of generating a stereogram, the method comprising:
capturing a plurality of images having different views;
a first step of partially loading a preset region of each of the plural captured images in a memory;
a second step of extracting a pixel at a corresponding location of each loaded preset region to generate a hogel image; and
a third step of repeatedly performing the first step and the second step on a remaining region of each of the plural images to generate a hogel image sequence.
